(19) United States
(12) Patent Application Publication
(10) Pub. No.: US 2015/0348528 A1
(43) Pub. Date: Dec. 3, 2015

(54) MANUAL TUBULAR BELL STRUCTURE

(71) Applicant: CHUN-SHEN YANG, TAICHUNG CITY 407 (TW)

(72) Inventor: CHUN-SHEN YANG, TAICHUNG CITY 407 (TW)

(21) Appl. No.: 14/291,196

(22) Filed: May 30, 2014

(51) Int. Cl. G10K 1/071

(52) U.S. Cl. CPC G10K 1/071

(57) ABSTRACT

A manual tubular bell structure is provided, which can be used conveniently and set with different audio frequencies. The manual tubular bell structure includes a pipe provided with a striker seat, a striker, and a striker head. The pipe has an audio frequency setting trough and a handle sleeve. The handle sleeve has an audio frequency setting hole. The audio frequency setting trough can be in different lengths/widths to set different audio frequencies. The audio frequency setting hole of the handle sleeve can be in different diameters to set different audio frequencies. The manual tubular bell of the present invention can provide different frequencies for people to perform.

### BACKGROUND OF THE INVENTION

1. Field of the Invention

The present invention relates to a manual tubular bell structure, and more particularly to a manual tubular bell structure able to set different audio frequencies for people to perform.

2. Description of the Prior Art

A manual tubular bell is an instrument able to sound “jingle”. A conventional manual tubular bell comprises a pipe. The bottom of the pipe is sealed to form a “resonance box” configuration. The pipe is provided with a striker which is able to swing. The striker has a striker head. The user can hold the pipe and swing the pipe, so that striker is swung with the striker head to strike the pipe to sound “jingle”. The conventional structure has some shortcomings. There is no configuration to change its audio frequency. It just sounds a single audio frequency. It is unable to set different audio frequencies quickly. For a different audio frequency, it is necessary to change the thickness of the pipe. That is to say, the pipe must be in a different thickness for a different audio frequency. It is not easy to precisely set an audio frequency by using a steel pipe of a different thickness. A high tech apparatus is required to test the product, so the manufacture cost is high. Accordingly, the inventor of the present invention has devoted himself based on his many years of practical experiences to solve these problems.

### SUMMARY OF THE INVENTION

The primary object of the present invention is to provide a manual tubular bell structure to improve the shortcomings of the prior art. The manual tubular bell structure of the present invention comprises a pipe with a handle sleeve to seal the bottom of the pipe. The handle sleeve has an audio frequency setting hole. The audio frequency setting hole can be in different diameters to set different audio frequencies. The pipe has an audio frequency setting trough. The audio frequency setting trough can be in different lengths/widths to set different audio frequencies. The present invention can use the pipe of the same material and thickness to set different audio frequencies. Therefore, people can use several pipes with different frequencies to perform.

### BRIEF DESCRIPTION OF THE DRAWINGS

FIG. 1 is an exploded view of the present invention;

FIG. 2 is a perspective view of the present invention;

FIG. 3 is a sectional view of the present invention;

FIG. 4 is a schematic view of the present invention when in use;

FIG. 5 is a perspective view showing an embodiment of the audio frequency setting hole of the present invention;

FIG. 6 is a perspective view showing another embodiment of the audio frequency setting hole of the present invention;

FIG. 7 is a perspective view showing an embodiment of the audio frequency setting trough of the present invention; and

FIG. 8 is a perspective view showing another embodiment of the audio frequency setting trough of the present invention.

### DETAILED DESCRIPTION OF THE PREFERRED EMBODIMENTS

Embodiments of the present invention will now be described, by way of example only, with reference to the accompanying drawings.

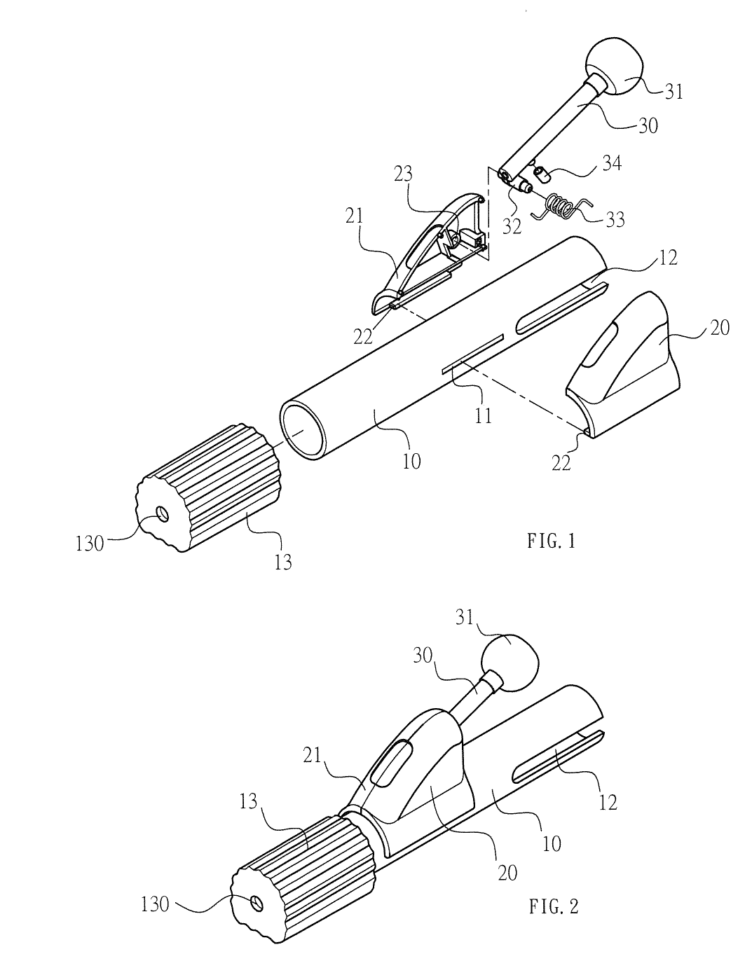

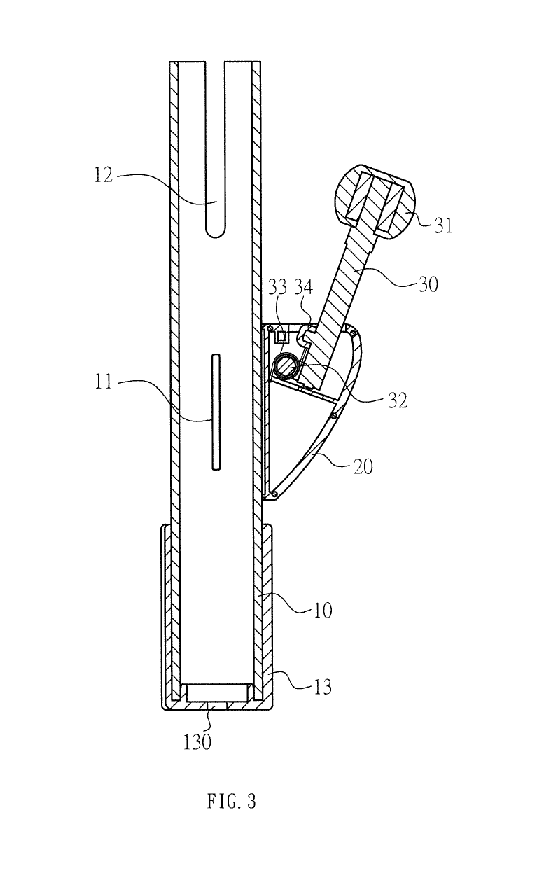

As shown in FIG. 1, FIG. 2, FIG. 3 and FIG. 4, the manual tubular bell structure of the present invention comprises a metallic pipe 10 having a positioning groove 11. The pipe 10 has an audio frequency setting trough 12 at an upper end thereof and a handle sleeve 13 at a lower end thereof to seal the bottom of the pipe 10. The handle sleeve 13 has an audio frequency setting hole 130. The present invention further comprises a pair of striker seats 20, 21. The striker seats 20, 21 each have an engaging rib 22 and an axial hole 23. The engaging rib 22 is engaged in the positioning groove 11. The pair of striker seats 20, 21 is provided with a striker 30. One end of the striker 30 has an axial rod 32 assembled to the axial holes 23 of the striker seats 20, 21. Another end of the striker 30 has a striker head 31. The axial rod 32 of the striker 30 is provided with an elastic member 33. The striker 30 is further provided with an elastic sleeve 34.

When in use, as shown in FIG. 4, the user holds the handle sleeve 13 to swing the pipe 10, so that the striker 30 is swung with the striker head 31 to strike the pipe 10 to sound “jingle”. Through the elasticity of the elastic member 33 and the elastic sleeve 34, the striker 30 with the striker head 31 can return automatically. Because the pipe 10 is a hollow pipe, it will provide a “resonance box” effect when the striker 31 strikes the pipe 10 to sound “jingle”. The present invention is able to provide different audio frequencies, as described below.

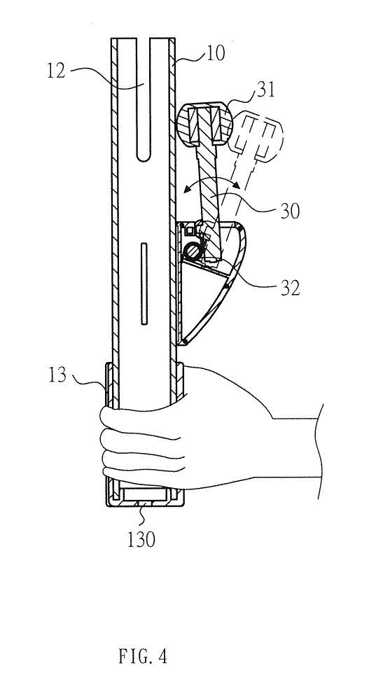

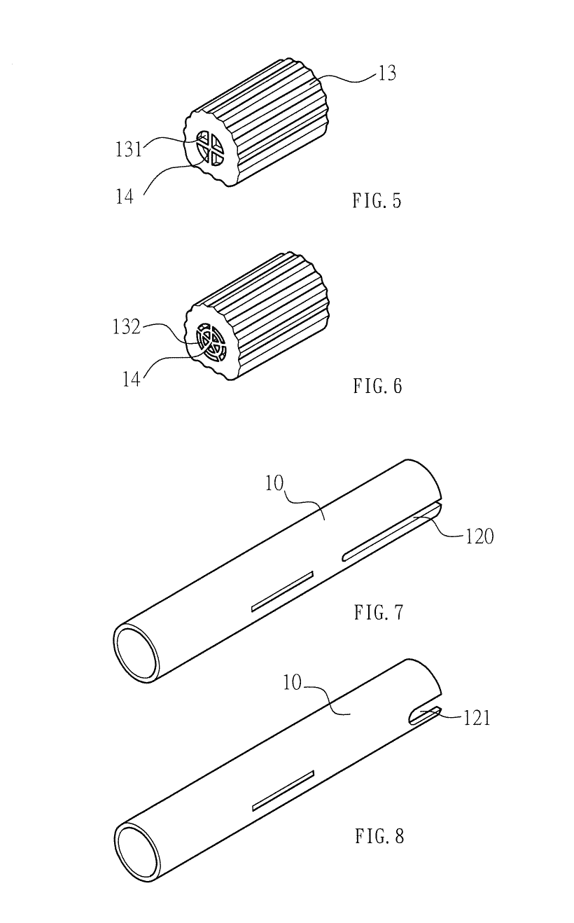

As shown in FIG. 1, the audio frequency setting hole 130 of the handle sleeve 13 is in a smaller diameter to generate a higher audio frequency. As shown in FIG. 5 and FIG. 6, the audio frequency setting holes 131, 132 of the handle sleeve 13 are larger in different diameters to generate a lower audio frequency. The audio frequency setting holes 131, 132 are provided with ribs 14 to prevent foreign objects from entering the pipe 10.

As shown in FIG. 1, FIG. 7, and FIG. 8, the audio frequency setting trough 12, 120, 121 of the pipe 10 can be in different lengths/widths to generate different audio frequency effects.

As the aforesaid, the present invention can use the pipe of the same material and thickness, through the handle sleeves 13 with the audio frequency setting holes in different diameters, to set different audio frequencies. Therefore, people can use several pipes with different frequencies to perform, not with a single audio frequency.

Although particular embodiments of the present invention have been described in detail for purposes of illustration, various modifications and enhancements may be made without departing from the spirit and scope of the present invention. Accordingly, the present invention is not to be limited except as by the appended claims.

1. A manual tubular bell structure, comprising a metallic pipe provided with a striker seat, the striker seat being provided with a striker, the striker being able to swing, the striker having a striker head, the striker head being adapted to strike the pipe to sound when the striker swings, the pipe having an audio frequency setting trough at an upper end thereof and a handle sleeve at a lower end thereof to seal a bottom of the pipe, the handle sleeve having an audio frequency setting hole, wherein the audio frequency setting trough can be set in different lengths and widths, and the audio frequency setting hole can be set in different diameters to generate different audio frequencies;
wherein the striker seat has an axial hole, the striker has an axial rod assembled to the axial hole, and the axial rod is provided with an elastic member, through elasticity of the elastic member, the striker is able to return automatically;
wherein the striker is further provided with an elastic sleeve, and elasticity of the elastic sleeve assists the striker in turning.

2. (canceled)

3. (canceled)
